(19) United States
(12) Patent Application Publication
(10) Pub. No.: US 2004/0215615 A1
(43) Pub. Date: Oct. 28, 2004

(54) Method and device for positioning a finger when verifying a person's identity

(76) Inventors: Alf Larsson, Bjarred (SE); Jerker Bergenek, Lund (SE); Helmuth Kristen, Lund (SE)

Correspondence Address: BURNS DOANE SWECKER & MATHIS L L P, POST OFFICE BOX 1404, ALEXANDRIA, VA, 22313-1404, US

(21) Appl. No.: 10/481,505

(22) PCT Filed: Jul. 1, 2002
(86) PCT No.: PCT/SE02/01298

Related U.S. Application Data
(60) Provisional application No. 60/302,664, filed on Jul. 5, 2001.

(30) Foreign Application Priority Data
Jun. 29, 2001 (SE) 0102376-1

(51) Int. Cl. G06F 17/30; H04L 9/32; G06F 7/00

(52) U.S. Cl. 707/9; 713/202; 382/115

(57) ABSTRACT

A method for verifying a person's identity using biometric data, comprises recording current biometric data that is input into a sensor by the person, and comparing previously recorded biometric reference data with the current biometric data in order to check whether an alignment condition has been fulfilled. If such is not the case, an indication is produced, on the basis of a result of the comparison, that the person is to change the input to the sensor in order to improve the alignment between the current biometric data and the biometric reference data. It is preferably also calculated and indicated how the user is to change the input. A computer program product and a device are also described.

### FIELD OF THE INVENTION

The present invention relates to a method for verifying a person's identity using biometric data and a computer program product and a device for this purpose.

### BACKGROUND ART

It is becoming increasingly common to use biometric data to verify a person's identity. The most usual method to use fingerprint data. The use of data relating for example, to hand prints, hand geometry, footprints, the retina, the iris, the voice and morphology of the face is, however, also known.

For the verification of a person's identity, current biometric data is recorded and compared with previously recorded biometric reference data to check whether the data fulfils a similarity condition. The data is recorded using some suitable sensor, such as a fingerprint reader, a camera or a microphone.

In order for the comparison to be meaningful, the input to the sensor must be made in essentially the same way when recording the reference data as when recording the current data. With the use of fingerprints, for example, the finger must be placed on the sensor in essentially the same position when recording the current fingerprint data as when recording the reference fingerprint data. Otherwise there is too little information that is common to both and the comparison becomes uncertain.

When recording voice data, it can, in addition, be important that the current data has a corresponding extent in time to the reference data. If the voice data consists of a specific word or sequence of words that the person whose identity is being verified speaks into a microphone, the word or sequence of words must thus preferably be spoken at the same speed when recording the current data as when recording the reference data.

At least concerning fingerprints, there is in addition a desire to use ever smaller sensors, as the sensors are expensive. This accentuates the problem of the finger needing to be placed in the same position when the current data is recorded as when the reference data was recorded.

A resultant problem is that users of fingerprint verification systems feel that it is inconvenient to use these, as they may need to make many attempts before the finger is in the correct position for the recording of the current data and accordingly before the verification system accepts the user's fingerprint. In addition, it is difficult for the user to know whether his current fingerprint has not been accepted due to incorrect positioning of the finger or for some other reason.

GB 2 331 613 discloses an apparatus for capturing a fingerprint, which at least partly solves the problem of how to ensure that the finger is placed in the same position when the current data is recorded as when the reference data was recorded. The apparatus comprises a fingerprint scanner for acquiring fingerprint image data, a computer for processing the fingerprint image data and a display. The computer determines a core position, i.e. a position of the centre of the ridge-flow pattern disruption, in the fingerprint image data acquired by the fingerprint scanner. The determined core position is compared with a required core position. If the determined core position is close to the required core position, the fingerprint image data is accepted. Otherwise, the user is prompted, e.g. via the display, to adjust the placement of his finger on the fingerprint scanner and new fingerprint image data is acquired.

The process described above must be used both when recording the reference fingerprint and when recording the current fingerprint which is to be compared with the previously stored reference fingerprint.

A disadvantage with the above process and apparatus is that they require the localisation of the core of the fingerprint, it being a well-known fact that some fingerprints lack an identifiable core.

### SUMMARY OF THE INVENTION

An object of the invention is to propose an alternative solution to the problem of how to ensure that the the sensor receives essentially the same input when recording the reference data as when reccordin the current data.

This object is achieved completely or partially by a method according to claim 1, a computer program product according to claim 16 and a device-according to claim 17.

More specifically, according to a first aspect, the invention relates to a method for verifying a person's identity using biometric data, comprising recording current biometric data which is input into a sensor by the person, comparing previously recorded biometric reference data with the current biometric data in order to check whether an alignment condition has been fulfilled, and if such is not the case, producing an indication that the person is to change the input to the sensor in order to improve the alignment between the current biometric data and the biometric reference data, on the basis of a result of the comparison.

According to the method, the current data and the reference data are thus compared to check whether they are sufficiently aligned, that is that they correspond to each other in space and/or time to a sufficient extent for a verification to be carried out in a meaningful way. If such is not the case, the result of the comparison is used to indicate to the user that he is to change the input to the sensor, in space and/or in time, in order to improve the alignment.

With this method, the person whose identity is to be verified can obtain an immediate feedback whether the input to the sensor is satisfactory or not.

Unlike GB 2 331613, the present method can be used for all fingerprints, because it uses previously recorded fingerprint reference data to check whether an alignment condition has been fulfilled. Thus, there is no need to locate a core point. This is an advantage, especially when a small fingerprint sensor is used.

Furthermore, this method allows the user to record the biometric reference data in an arbitrary way in relation to the sensor. The alignment need only be carried out when recording the current biometric data.

In one embodiment, the person can, in addition, obtain an indication of how he is to correct any shortcomings. This results in a more user-friendly system. Moreover, time can be saved by the user requiring fewer attempts before the input to the sensor is correct and the identity can accordingly be verified.

The method is used advantageously to provide feedback to a user about how he is to position his finger on a fingerprint sensor. The method is particularly advantageous with the use of small fingerprint sensors where the positioning of the finger in relation to the sensor is critical and where it can be particularly difficult to position the finger in a correct way.

In one embodiment, the previously recorded biometric reference data further comprises a first subset of a digital representation of a previously recorded fingerprint and the current biometric data comprises a digital representation of a current fingerprint, the step of comparing comprising correlating the first subset with the current digital representation of the fingerprint.

The subset can, for example, be a partial area of the previously recorded fingerprint, be an orientation map, which represents the ridge flow of the previously recorded fingerprint or can comprise a plurality of so-called minutiae points of the previously recorded fingerprint. As only a subset of the fingerprint is used for the comparison, the indication that the finger must be moved can be produced without access to complete information about the reference fingerprint, which is advantageous from a security point of view.

In a corresponding way, it would be possible to use a subset of any other type of biometric data in order to correlate this with current biometric data.

The method may be particularly advantageous when the comparison between the current data and the reference data is carried out in a first unit, which receives the biometric reference data from a second unit in which the verification is to be carried out and in which additional biometric reference data is stored. In this case, the additional biometric reference data never needs to leave the second unit, which is advantageous from a security point of view. As a second subset of the current biometric data is not transmitted to the second unit until the alignment condition has been fulfilled, time is saved as there are then no attempts at carrying out a verification that is already bound to fail on account of a lack of alignment between the current data and the reference data.

### BRIEF DESCRIPTION OF THE DRAWINGS

The present invention will now be described in greater detail by means of an exemplary embodiment and with reference to the accompanying drawings, in which

FIG. 1 shows an example of a system for verifying a fingerprint;

FIG. 2 schematically shows a flow chart for recording a template;

FIGS. 3a and b schematically show an image of a reference fingerprint and an image of a current finger print respectively; and

FIG. 4 schematically shows a flow chart of an example of a method according to the invention.

### DESCRIPTION OF A PREFERRED EMBODIMENT

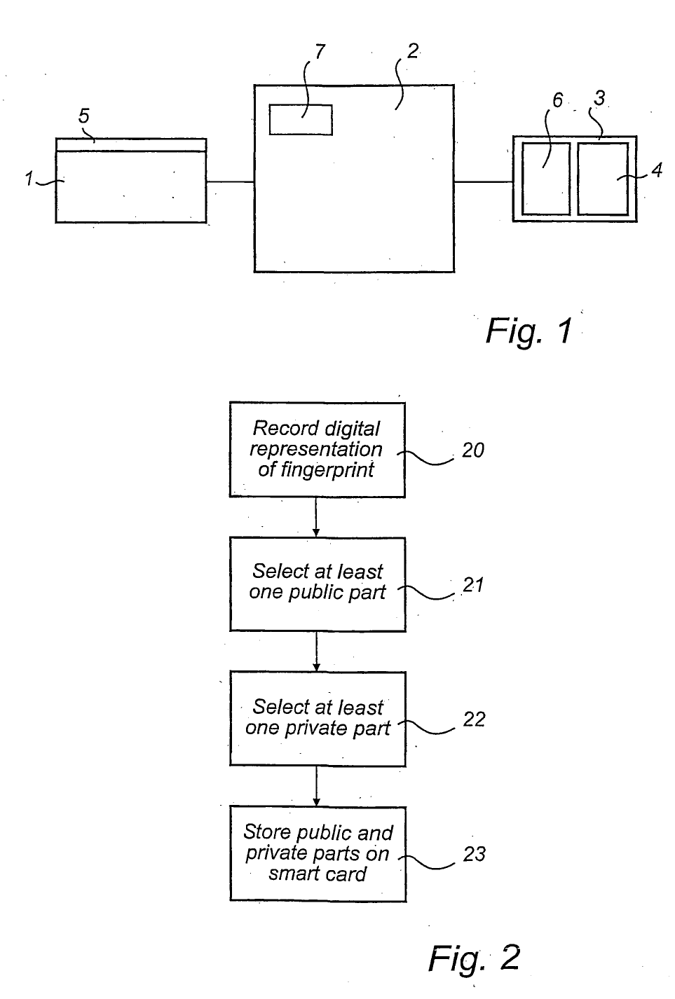

FIG. 1 schematically shows an example of a system for verifying fingerprints, which system comprises a sensor 1 for recording fingerprints, a first unit 2, which in the following is called the processing unit, for processing fingerprint data, and a second unit 3 that comprises a template memory 4 for storing reference fingerprint data.

The sensor 1 can, for example, be capacitive, optical, thermal or pressure-sensitive. It can be of the flat-bed type, that is of a type where the user holds his finger still when recording the fingerprint, or of the motion type, that is where the user moves his finger over the sensor while the fingerprint is recorded. It has a sensor surface 5 that makes it possible to record a fingerprint. The size of the surface can vary. It can enable the recording of a complete fingerprint from the first joint of the finger or a partial fingerprint from a larger or smaller part of the first joint of the finger.

The sensor 1 is connected to the processing unit 2, which can be a unit that is dedicated to processing fingerprints or a computer of standard type that has been provided with suitable software. In the former case, the processing unit can, for example, comprise a processor with program memory and working memory or special-purpose hardware, such as an ASIC (Application-Specific Integrated Circuit) or an FPGA (Field-Programmable Gate Array), or digital or analogue circuits, or any suitable combination of the above.

The template memory 4 of the second unit 3 can be any known type of memory that makes it possible to store reference fingerprint data. The unit can be integrated with the processing unit or can be free-standing.

The second unit can, in particular, be a portable unit that is personal to the user. It can, for example, consist of a so-called smart card or a corresponding type of portable unit, that stores the user's personal reference fingerprint data and that, in addition to memory, contains a processor 6, using which the actual verification of the fingerprint can be carried out. If the second unit is a smart card or the like, the system may need to comprise a smart card reader (not shown) that can read off the information on the smart card. The smart card reader can be an integrated part of the processing unit or a separate unit connected to the processing unit.

The second unit 3 can alternatively be a unit that is located at a distance from the processing unit 2, with the communication between the processing unit and the second unit taking place, for example, via some form of communication network. The second unit can, for example, be a computer in a bank.

In the following, it is assumed that the second unit 3 is a smart card that is read off in a smart card reader (not shown).

The system can additionally comprise indicating means, the function of which is to indicate that the user is to move his finger in relation to the sensor and/or to indicate how the user is to move his finger in relation to the sensor and/or to indicate that the verification of the identity of the user has been successful or has failed. FIG. 1 shows the indicating means 7 as part of the processing unit 2. They can, however, equally well be located in or on the sensor 1. The indicating means can, for example, consist of a display on which the indications are shown, of light-emitting diodes that give indications in the form of light signals or of some other suitable means that can give indications to the user as described above.

Now assume that a user is to record reference fingerprint data that is to be stored in the template memory 4 on the smart card 3. This recording can be carried out by the system in FIG. 1. In the following, the reference fingerprint data is called a template. A template can comprise a reference fingerprint in the “raw” or unprocessed form in which it is recorded. Normally, however, a template contains processed and compressed data, which is the case in this example.

FIG. 2 shows a flow chart of a method for creating a template with a private and a public part. The template is to be stored in the memory 4 of the smart card 3. The private part of the template is intended to be used exclusively in the smart card for carrying out the verification itself. The public part is intended to be used in the processing unit for aligning the current fingerprint data with the reference fingerprint data in the template so that a suitable subset of the current fingerprint data can be selected and transferred to the smart card 3 where it is to be matched with the private part of the template for verification of the user's identity. The alignment in the processing unit is carried out by the public part of the template being correlated with the current fingerprint. The advantages of the division of the template into a private and a public part are apparent from the following.

The method can be implemented as follows. Firstly, in step 20, a first digital representation or grey-scale image of the user's fingerprint is recorded using the sensor 1. In the processing unit, the recorded image is checked, so that, for example, it is ensured that there is actually a fingerprint in the image, that the fingerprint occupies a sufficiently large part of the image and that the fingerprint is sufficiently clear.

In addition, it is checked whether the user has applied his finger with sufficient pressure on the sensor and whether any moisture on the user's finger has made it impossible for the sensor to distinguish between “ridges” and “valleys” on the finger. If necessary, the recording step is repeated.

When a grey-scale digital image of sufficiently good quality has been recorded, the image is converted into binary form. The conversion into binary form consists of the image's pixels being compared with a grey-scale threshold value. The pixels that have a value that is lower than the grey-scale threshold value are converted to white and those that have a value that is higher than the grey-scale threshold value are converted to black. The grey-scale threshold value can be the same for the whole image or can vary between different parts of the image. The algorithm for the conversion into binary form can be further refined, so that the pixels are compared with the surrounding pixels, for example in order to avoid individual pixels becoming white if all the surrounding pixels are black. Further processing of the image can also be carried out, such as changing the resolution and/or improving the contrast.

After the conversion into binary form, in step 21, a partial area, below called the public partial area, is selected from the image for storage in the public part of the template. The area can be selected in various ways. One way is to use the following three quality criteria: 1) Distinctness, that is how easy a partial area is to convert into binary form, 2) Uniqueness, that is how unique a partial area is, and 3) Geographical location, that is where a partial area is located in the fingerprint.

The uniqueness can, for example, be checked by correlating the partial area with the surrounding area and selecting a partial area with little correlation with the surrounding area. Alternatively, it is possible to search for partial areas with features, also called minutiae points, that is characteristic points in the fingerprint, such as points where a line in the fingerprint divides or ends (also called ridge endings and ridge bifurcations).

Regarding the geographical location, partial areas in the centre of the image are preferred, as there is then least risk of the partial areas not being included in a current fingerprint recorded later. In addition, the image of the fingerprint will be least deformed in the centre when the user presses his finger against the sensor with different pressures.

The partial area that best corresponds to the quality criteria listed above is selected to form the public partial area. A single public partial area in the middle of the image is preferably selected, so that as little information as possible about the user's fingerprint is available in the public part of the template. However, more public partial areas can be selected in order to achieve a more certain correlation of the public part of the template with the digital representation of the current fingerprint and thereby achieve a more certain alignment or orientation of the template in relation to the current fingerprint.

When the public partial area has been selected, in step 22, at least one but preferably a plurality of partial areas, below called private partial areas, are selected for storage in a private part of the template on the smart card 3. The private partial areas are preferably selected in accordance with the same quality criteria as the public partial area/areas. Preferably six private partial areas are selected. More or fewer partial areas can be selected depending upon the required level of certainty, the required speed of the matching on the smart card 3 and available processor capacity on the smart card 3.

In this example, the size of the selected public and private partial areas is 48×48 pixels, but can easily be adapted by persons skilled in the art as necessary.

In association with the private partial areas being selected, their location in relation to a reference point is also determined. The reference point can, for example, be selected as the centre in the public partial area or in one of these if there are more than one. Other well-defined reference points can of course also be selected, for example using features. The location of the private partial areas is given as coordinates, for e.g. the centre in the private partial areas, in relation to the reference point. These coordinates are stored as part of the public part of the template.

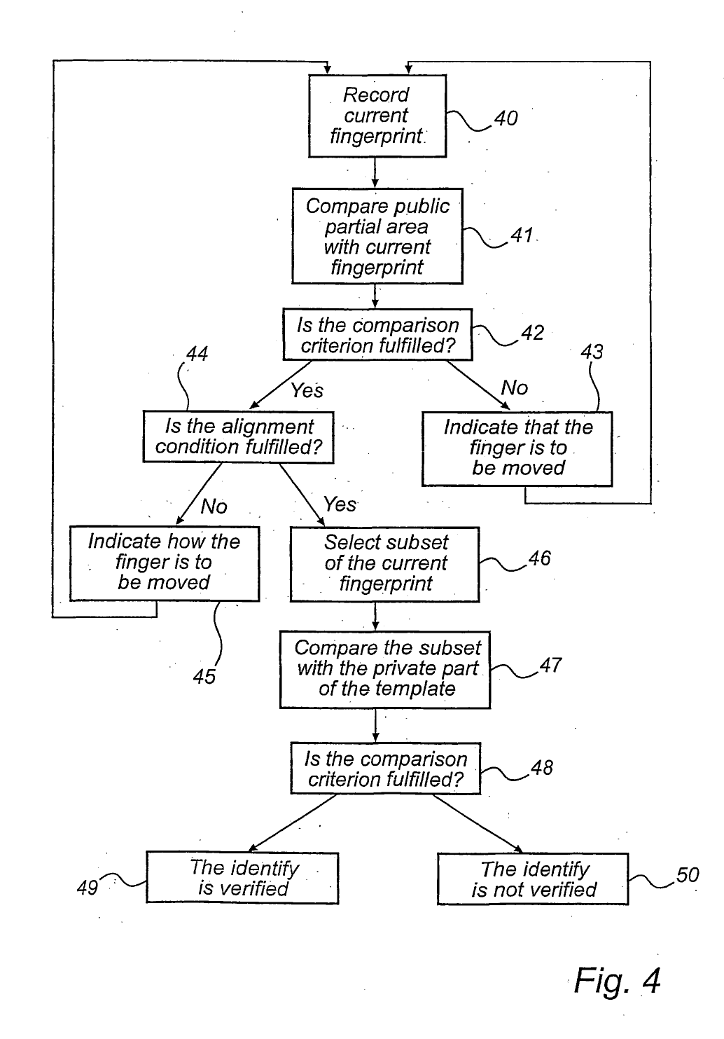

Before the template is transferred to the smart card, a test matching is carried out with an additional image of the user's fingerprint recorded using the sensor. The test matching is carried out essentially in accordance with the method that will be described below with reference to FIG. 4. If the additional image and the template match each other, the template is considered to be acceptable.

In step 23, the public and private parts of the template are then transferred from the processing unit to the memory 4 of the smart card 3. The public part of the template will thus contain the public partial area/areas and coordinates for the location of the private partial areas in relation to a reference point. Its private part will contain the private partial areas. Comparison criteria can also be stored in the private part in the form of threshold values for what level of correspondence is to be achieved by the matching of the private partial areas with the partial areas of the current fingerprint in order for the template and the current fingerprint to be considered to originate from the same individual. The threshold values can, for example, comprise a first threshold value that indicates the level of correspondence required between an individual private partial area and a corresponding partial area in the digital representation of the current fingerprint. This first threshold value can apply to all the private partial areas. The threshold values can further comprise a second threshold value that indicates how many of the private partial areas must fulfil the first threshold value. They can also comprise a third threshold value that indicates the level of correspondence required between the private partial areas taken as a whole and corresponding areas in the current fingerprint. The threshold values can, but do not need to, apply to the public partial area.

The partial areas are preferably stored in the form of compressed bitmaps.

When the template is transferred to the memory 4 of the smart card 3, if so required, additional sensitive information can be transferred from the computer and stored in the memory of the smart card.

It should be pointed out that steps 21-23 in the method described above are carried out using the processing unit 2, for example using a computer program in this.

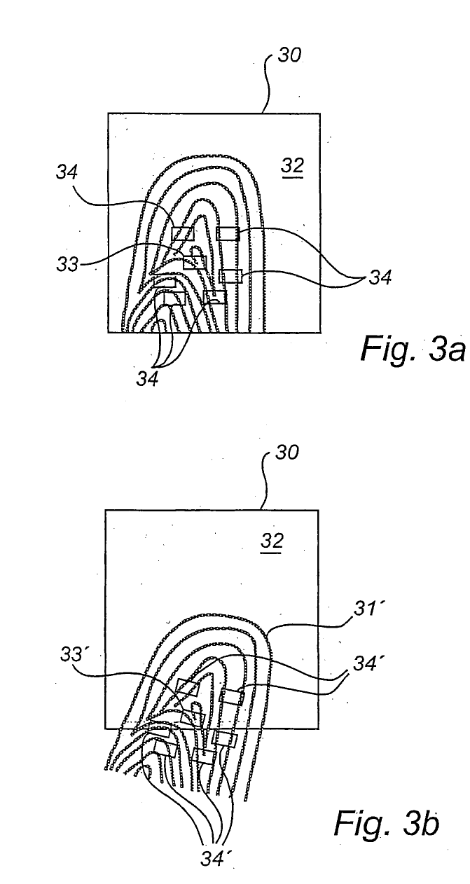

FIG. 3a schematically shows the image that is recorded by the sensor 1 when recording the reference fingerprint from which the template is produced. The solid frame 30 around the fingerprint corresponds to, the edge of the sensor surface 5 and thereby of the image that is recorded by the sensor 1. As shown in FIG. 3a, when recording the reference fingerprint, the user's finger was in a particular position on the sensor, below called the first position 31. This position is fairly central on the sensor. The whole surface of the sensor is not, however, taken up by the fingerprint, but the image also contains background 32. In FIG. 3a, the public partial area 33 and the private partial areas 34 have also been indicated. It should be emphasised that FIG. 3a, like the other figures, is extremely schematic and is only intended to illustrate the principles of the invention. In particular, the size relationships of different elements in the figures do not necessarily conform to reality.

Now assume that the user wants to verify his identity. Accordingly, he places his smart card 3 in the smart card reader (not shown) and places the same finger on the sensor 1 that he used when recording the reference fingerprint. It is, as will be shown below, desirable for the user to place his finger in or near the first position that was used when recording the reference fingerprint. As the user does not know what this position is, it is probable that he will place his finger in a second position that differs from the first position to a greater or lesser degree.

When the user has placed his finger in the second position on the sensor 1, a second scale-scale digital image is recorded, step 40, in the same way as described above. The image constitutes a digital representation of the person's current fingerprint. Quality control is applied to the image, preferably in the same way as when recording the template, and the image is converted into binary form. Thereafter the processing unit 2 reads the public part of the template on the smart card 3.

In step 41, the public partial area incorporated in the public part of the template is correlated or compared with the current fingerprint converted into binary form. The correlation can be carried out using all of the current fingerprint or preferably using a part of a predetermined size, for example 100×100 pixels, in the middle of the image. During the correlation the public partial area “sweeps” over the image of the current fingerprint and carries out a comparison pixel by pixel in each position. If a pixel in the template corresponds to a pixel in the image of the current fingerprint, a particular value, for example 1, is added to a total. If the pixels do not correspond, then the total is not increased. When the public partial area of the template has swept over the whole image or the selected area of this, a position is obtained where the public partial area of the template best correlates with or overlaps the current fingerprint. The public partial area can also be rotated in relation to the image of the current fingerprint, in order to determine whether a better correlation can be obtained.

When the translation and the rotation have been carried out and the best correlation position of the public partial area of the template relative to the current fingerprint has been found, then in step 42 the correlation value obtained is compared with a previously determined first comparison criterion, which in this case consists of a reference total. If the correlation value is lower than the reference total, then the correlation is considered to have failed, but if the correlation value is equal to or higher than the reference total, then the process continues with step 44.

The correlation can fail for at least two reasons. Either the current fingerprint does not originate from the person from which the reference fingerprint has been recorded and so there is quite simply no correspondence with the public partial area in the current fingerprint, or the current fingerprint and the template originate from the same person, but the person in question is holding his finger in such a position in relation to the sensor 1 that the correspondence with the public partial area does not lie within the sensor surface 5. The processing unit 2 cannot determine whether the failed correlation is due to any one of these two reasons. In this example, the processing unit 2 therefore only gives an indication to the person that he is to move his finger and repeat the recording, step 43, after which the process goes back to step 40. If, after a predetermined number of attempts, the correlation has not succeeded, the processing unit 2 can indicate that the current fingerprint is not accepted.

If the correlation succeeds, however, this indicates that there is a correspondence between the current fingerprint recorded by the sensor 1 and the public partial area. It is, however, still not certain that the conditions are right for a subsequent verification of the fingerprint to succeed. If the position of the finger when recording the current fingerprint differs greatly from the position of the finger when recording the reference fingerprint, there is a great risk that one or more of the private partial areas that are used for the verification do not have any correspondence in the image of the current fingerprint, but instead are on a part of the finger that is located outside the sensor surface 5. Depending upon which threshold values are used for the verification, it can be the case that the verification is already bound to fail or at least has-very little probability of succeeding.

The above is illustrated in FIG. 3b, which shows that the user placed his finger in a second position 31′ further down on the surface of the sensor and at a slight angle in relation to the first position in which the reference fingerprint was recorded. In FIG. 3b, the areas have also been marked that correspond to the public partial area 33 and the private partial areas 34 in FIG. 3a. Corresponding areas in the current fingerprint have been given the same reference number, but with the addition of the ′ sign. The public partial area 33′ in the current fingerprint is still on the surface of the sensor and is thus included in the image of the current fingerprint recorded by the sensor. The same applies to both the uppermost private partial areas 34′. The four lowermost private partial areas lie, however, completely or partially outside the frame 30 and will thus not be included in the image of the current fingerprint.

If the verification were to be carried out, it would thus probably fail, which would then be indicated to the user. The user would not then know the reason for the failure. Was it due to a technical problem or to the finger being positioned incorrectly? The user would then try to record a new current fingerprint. It would probably require several attempts before the user found the correct position for the finger on the sensor 1. Each attempt takes a certain amount of time, particularly when the verification is carried out on the smart card 3 that has limited memory and processor capacity.

This problem is solved by determining whether the conditions are right for the subsequent verification to succeed, by determining whether an alignment condition is fulfilled, step 44, instead of always proceeding with the verification when the public partial area correlates with a partial area in the current fingerprint.

This is carried out as follows: It has been determined how the template and the image are oriented in relation to each other by the correlation of the public partial area of the template with the image of the current fingerprint. This can also be regarded as determining in what position the first image of the reference fingerprint and the second image of the current fingerprint overlap each other. When this relative orientation has been determined, the point in the image of the current fingerprint that corresponds to the reference point in the image of the reference fingerprint can be determined. After this, the coordinates in the public part of the template are used to calculate where the parts corresponding to the private partial areas are situated. The calculation can be carried out based on the size of the surface of the sensor or directly in the image. If the coordinates indicate that all the private partial areas lie within the current image of the fingerprint, the alignment condition in this example is fulfilled and the conditions are right for the verification to succeed. If one or more areas are missing in the image, as is the case in FIG. 3b, the conditions may not be right for the verification to succeed, depending upon the alignment condition. If the alignment condition is not fulfilled, this is indicated to the user. In the simplest case, just an indication is given that the user is to move his finger. Once the reference point is known, however, it is possible also to calculate how the user is to move his finger in order to improve the alignment. In the case in FIG. 3b, for example, it is simple to calculate that the user needs to move his finger upwards on the sensor in order to improve the alignment with the reference fingerprint in FIG. 3a. This is indicated to the user by means of words, images, symbols, light or sound signals or in some other suitable way, step 45. The process then goes back to step 40.

Thus, not until it has been ensured that the alignment condition has been fulfilled and that the conditions are right for the verification to succeed, is a subset of the current fingerprint selected, step 46, and sent from the processing unit 2 to the smart card 3 for carrying out the verification. For this purpose, the reference point and the coordinates are used to determine which parts of the image of the current fingerprint are to be sent to the smart card 3 for comparison with the private partial areas. More specifically, a partial area of a predetermined size is selected in the current fingerprint around each point that is defined by the coordinates in the public part of the template. The partial areas in the current fingerprint can, however, be somewhat larger than the corresponding private partial areas in the template, in order to compensate for any deformation of the fingerprint if the finger is applied on the sensor with a different pressure when recording the image of the current fingerprint. These partial areas of the current fingerprint are then transferred to the smart card 3.

It should be emphasised that, in this example, the same technique is thus used to determine whether the image of the current fingerprint is sufficiently aligned with the image of the reference fingerprint, and also to select the partial areas that are to be sent to the smart card and used for the actual verification.

The areas can be sent to the smart card 3 in a predetermined sequence, so that the processor 6 on the smart card knows which area is which. As another alternative, the coordinates for the position of the areas in the current fingerprint can be included.

In step 47, the processor 6 on the smart card 1 compares the transmitted subset with the private part of the template. More specifically, the transmitted partial areas of the current fingerprint are thus matched with the private partial areas in the template. This matching is much less time-consuming than if, for example, the private partial areas had had to be matched with the whole image of the current fingerprint, as the private partial areas now only need to be matched in a limited number of positions with corresponding partial areas from the current fingerprint. Therefore the matching can be carried out on the smart card, in spite of the fact that the processor in this usually has fairly limited capacity. In addition, if the rotational position has been determined in the processing unit, no rotations need to be carried out.

The matching can, for example, be carried out in the way described above, where a point total is calculated on the basis of pixel similarity. When the transmitted partial areas of the current fingerprint have been compared with the private partial areas of the template, a total matching value is obtained between 0% (that is no matching at all) and 100% (that is complete matching). This matching value is compared with a second comparison criterion in the form of a predetermined threshold value, step 48, that can be stored in the private part of the template. If the matching value is equal to or higher than the threshold value, then the identity is regarded as verified, step 49, and the user can be granted access to the sensitive information that is stored on the card. If the matching value is lower than the threshold value, the identity is regarded as not verified, step 50, and the user is denied access to the sensitive information. Alternatively, the matching value for each individual partial area can first be compared with a threshold value and the number of matching partial areas can be determined.

Further examples of how partial areas in a fingerprint can be selected and how a partial area in a reference fingerprint can be compared with a partial area in a current fingerprint are to be found in Applicant's International Patent Application PCT/SE99/00553.

It should be pointed out that, in this embodiment, steps 41-46 above are carried out in the processing unit 2, for example using a computer program in this, and that steps 47-50 are carried out by the processor 6 on the smart card 3.

Alternative Embodiments

Even though a special embodiment of the invention has been described above, it will be obvious to those skilled in the art that many alternatives, modifications and variations are possible in the light of the above description.

The invention has been described above by an example that refers to fingerprints. The principles of the invention can, however, equally well be applied to other types of biometric data, such as data relating to hand prints, hand geometry, footprints, the retina, the iris, the voice and morphology of the face.

The alignment between the current data and reference data can, as discussed above, take place in time and/or space. In the example above, the alignment is achieved by the finger being moved in relation to the surface of the sensor essentially in the plane of the sensor surface. A further alignment can, however, be carried out in the plane essentially at right angles to the surface of the sensor. This is because the width of the lines in the recorded fingerprint and the density of these are affected by how hard the user presses his finger against the surface of the sensor, that is in some respects by the position of the finger at right angles to the surface of the sensor. In the example above, when the best correlation position has been found for the public partial area in relation to the current fingerprint, it can also be checked how well the line width and/or the density in the public partial area correlate with corresponding areas in the current fingerprint. If the correlation (the alignment) is not sufficiently good, an indication can be given to the user that he is to change the pressure. It can also be calculated how the user is to change the pressure and an indication of this can be given.

When checking whether the alignment condition is fulfilled, that is in the example above if a sufficient number of private partial areas are to be found in the current fingerprint for the conditions to be right for the verification to succeed, it is assumed that the user has pressed his finger against the surface of the sensor with approximately the same pressure when recording the current fingerprint and when recording the reference fingerprint, so that the same amount of the fingerprint is imaged in the given position. Even if the finger is held in the correct position on the surface of the sensor, it is not certain that the alignment condition will be fulfilled, since if the user presses his finger against the surface of the sensor with uneven pressure, it may be that a part of the fingerprint is not recorded. If, for example, the user in FIG. 3b presses the uppermost part of his finger very lightly or not at all against the surface of the sensor, it may be that the upper part of the fingerprint is not imaged by the sensor and that accordingly both the uppermost private partial areas 34′ are not present in the image of the current fingerprint, even though they lie within the framework of the image and of the sensor surface. In order to prevent the alignment condition being judged to be fulfilled in such a case and the areas being sent to the smart card 3 for verification, it is possible to extract the fingerprint or remove the background 32 from the image and just work with the imaged fingerprint.

In the example above, partial areas of the digital representation of the reference fingerprint are used for correlation, alignment and verification. Alternatively, minutiae points or a ridge flow orientation map could be used for one or more of said purposes. The public part of the template could, for example, contain information about the relative positioning of a plurality of minutiae points, which are sent to the processing unit and correlated with minutiae points in the current fingerprint. If the alignment condition is fulfilled, for example if a sufficient number of said minutiae points are to be found in the current fingerprint, a subset of the current fingerprint is selected on the basis of the result of the correlation and is sent to the smart card. The subset can, for example, be one or more partial areas, additional minutiae points or some other information, such as the type of the correlated minutiae points. If the alignment condition is not fulfilled, an indication can be produced for the user, on the basis of the location of the minutiae points which are to be found in the current fingerprint, regarding how he is to move his finger in order to improve the alignment.

The examples relating to fingerprints can easily be transferred to other biometric data.

The alignment conditions can be different to those mentioned above. For example, they can relate to an alignment in time, where the distance in time between different subsets of the current data and the reference data is compared.

In the example above, one public partial area is used. This is not necessary, as several public partial areas can be used. The advantage of this is that a more certain determination is obtained of how the template is oriented in relation to the image of the current fingerprint. Another advantage is that if a user has received an injury to his finger after the template was recorded which means that the first partial area does not correlate, optionally a second public partial area can be used for the correlation.

The public part of the template can also contain other information that makes it possible to determine a reference point in the sample image, for example a specification of a reference point on the basis of a relationship between line transitions or the like.

It would also be possible to let the public part of the template only contain information, for example coordinates, giving the position of the private partial areas in relation to a reference point and to let the reference point be a predetermined point in the actual fingerprint, that is not in the image, which point can be identified in a certain way. In PCT/SE99/00553, various ways are described of finding a reference point in a fingerprint.

In the example above, it is described how the private partial areas are selected in accordance with certain quality criteria. It is, of course, possible to select these areas in accordance with other criteria. A variant can be always to select the areas in a predetermined position in relation to the reference point. In such a case, the public part of the template does not need to contain coordinates for the location of the private areas.

In the example above, the template is stored on a portable unit. It could also be an advantage to use the method described above for communication between a processing unit and a stationary unit, for example a stationary computer. Such an example could be when biometric information is used to verify a user's, identity when he wants to connect to, for example, a bank on the Internet. The biometric template can then be stored in a stationary data carrier at the bank, while the user has a fingerprint sensor and software for carrying out the part of the method described above that is carried out in the processing unit. An advantage of using the method in this application is that the user can record a correctly aligned current image of his fingerprint more quickly and as a result the verification process works more rapidly and is perceived as more convenient by the user.

Finally, it should be pointed out that the comparison of a public partial area described above and the current biometric data can be carried out in many other ways than the calculation of point totals as described above. For example, multiplication of pixels corresponding to each other and subsequent integration can be used to obtain a correlation. The matching can thus also be carried out on images that have not been converted into binary form.

1. A method for verifying a person's identity using biometric data, comprising the steps of
recording the current biometric data that is input into a sensor by the person,
comparing previously recorded biometric reference data with the current biometric data in order to check whether an alignment condition has been fulfilled, and
if such is not the case, producing an indication that the person is to change the input to the sensor in order to improve the alignment between the current biometric data and the biometric reference data, on the basis of a result of the comparison.

2. A method according to claim 1, in which the indication comprises information about how the person is to change the input to the sensor in order to improve the alignment between the current biometric data and the biometric reference data.

3. A method according to claim 1, in which the biometric data consists of fingerprint data.

4. A method according to claim 1, in which recording the current biometric data comprises recording current fingerprint data from a finger of the person when the finger is placed in a first position in relation to the sensor, and in which the previously recorded biometric reference data is reference fingerprint data that has been recorded with the finger placed in a second position in relation to the sensor, and in which said check comprises checking whether the first position essentially corresponds to the second position.

5. A method according to claim 4, in which producing an indication that the person is to change the input comprises indicating how the person is to move his finger in relation to the sensor in order to improve the alignment.

6. A method according to claim 1, in which said check that an alignment condition is fulfilled comprises checking whether a density condition is fulfilled.

7. A method according to claim 1, in which recording the current biometric data comprises recording a first image of the surface of the sensor, the biometric reference data having been recorded on the basis of a second digital image of the surface of the sensor, and in which comparing comprises determining to what extent the first image overlaps the second image.

8. A method according to claim 7, in which comparing further comprises determining whether the overlapping area is sufficiently large for the verification to be carried out.

9. A method according to claim 1, in which the previously recorded biometric reference data comprises a first subset of a digital representation of a previously recorded fingerprint and the current biometric data comprises a digital representation of a current fingerprint and in which comparing comprises correlating the first subset with the digital representation of the current fingerprint.

10. A method according to claim 9, in which the first subset consists of a first partial area of the digital representation of a previously recorded fingerprint.

11. A method according to claim 10, in which the first partial area constitutes part of a template, that further comprises additional partial areas of the digital representation of the reference fingerprint and information about the position of the additional partial areas in the reference fingerprint in relation to the first partial area, and in which comparing further comprises determining, using the information about the position of the additional areas in the reference fingerprint, whether corresponding areas are to be found in the recorded current fingerprint.

12. A method according to claim 11, further comprising calculating how the person is to move his finger in order to improve the alignment using the information about the position of the additional partial areas in the reference fingerprint.

13. A method according to claim 9, in which the first subset consists of a plurality of minutiae points in the digital representation of a previously recorded fingerprint.

14. A method according to claim 1, in which comparing is carried out in a first unit which receives the biometric reference data from a second unit in which the verification is to be carried out and in which additional biometric reference data is stored.

15. A method according to claim 14, in which a second subset of the current biometric data is transmitted to the second unit only when the alignment condition has been fulfilled.

16. A computer program product comprising a computer program for carrying out a method according to claim 1.

17. A device for verifying a person's identity using biometric data, comprising a sensor for recording current biometric data that is input into the sensor by the person, a processor that is arranged to compare previously recorded biometric reference data with the current biometric data in order to check whether an alignment condition has been fulfilled, and if such is not the case, to indicate how the person is to change the input into the sensor in order to improve the alignment between the current biometric data and the biometric reference data.

18. A device according to claim 17, in which the previously recorded biometric reference data comprises a first subset of a digital representation of a previously recorded fingerprint and the current biometric data comprises a digital representation of a current fingerprint and in which the processor is arranged to correlate the first subset with the digital representation of the current fingerprint when comparing the previously recorded biometric reference data with the current biometric data.

19. A device according to claim 18, in which the first subset consists of a first partial area of the digital representation of a previously recorded fingerprint.

20. A device according to claim 19, in which the first partial area constitutes part of a template, that further comprises additional partial areas of the digital representation of the reference fingerprint and information about the position of the additional partial areas in the reference fingerprint in relation to the first partial area, and in which the processor is further arranged to determine, using the information about the position of the additional areas in the reference fingerprint, whether corresponding areas are to be found in the recorded current fingerprint.

21. A device according to claim 20, in which the processor is further arranged to calculate how the person is to move his finger in order to improve the alignment using the information about the position of the additional partial areas in the reference fingerprint.

22. A device according to claim 17, in which the first subset consists of a plurality of minutiae points in the digital representation of a previously recorded fingerprint.

23. A method according to claim 17, in which the biometric reference data is received from a second unit in which the verification is to be carried out and in which additional biometric reference data is stored.

24. A method according to claim 23, in which the processor is arranged to transmit a second subset of the current biometric data to the second unit only when the alignment condition has been fulfilled.

25. A method according to claim 2, in which the biometric data consists of fingerprint data.

26. A method according to claim 2, in which recording the current biometric data comprises recording current fingerprint data from a finger of the person when the finger is placed in a first position in relation to the sensor, and in which the previously recorded biometric reference data is reference fingerprint data that has been recorded with the finger placed in a second position in relation to the sensor, and in which said check comprises checking whether the first position essentially corresponds to the second position.

27. A method according to claim 3, in which recording the current biometric data comprises recording current fingerprint data from a finger of the person when the finger is placed in a first position in relation to the sensor, and in which the previously recorded biometric reference data is reference fingerprint data that has been recorded with the finger placed in a second position in relation to the sensor, and in which said check comprises checking whether the first position essentially corresponds to the second position.

28. A method according to claim 25, in which recording the current biometric data comprises recording current fingerprint data from a finger of the person when the finger is placed in a first position in relation to the sensor, and in which the previously recorded biometric reference data is reference fingerprint data that has been recorded with the finger placed in a second position in relation to the sensor, and in which said check comprises checking whether the first position essentially corresponds to the second position.
